(19) United States
(12) Patent Application Publication
(10) Pub. No.: US 2013/0164135 A1
(43) Pub. Date: Jun. 27, 2013

(54) Active Noise Suppression on a Wind Turbine

(71) Applicant: Richard A. Himmelmann, Beloit, WI (US)

(72) Inventor: Richard A. Himmelmann, Beloit, WI (US)

(73) Assignee: Clipper Windpower, LLC, Carpinteria, CA (US)

(21) Appl. No.: 13/332,655

(22) Filed: Dec. 21, 2011

(51) Int. Cl. F03D 11/00; G10K 11/16

(52) U.S. Cl. 416/146 R; 381/71.1

(57) ABSTRACT

A system and method for actively suppressing a noise signature from a noise emitting component on a wind turbine is disclosed. The system and method may include at least one active noise measuring device capable of measuring an original noise signature of the noise emitting wind turbine component, a controller for determining an inverted noise signature for the original noise signature, an amplifier for amplifying the inverted noise signature and at least one speaker for emitting the amplified inverted noise signature.

### FIELD OF THE DISCLOSURE

The present disclosure relates generally to wind turbines and, more particularly, relates to a system and method for actively suppressing noise emitted by various components on a wind turbine.

### BACKGROUND OF THE DISCLOSURE

A utility-scale wind turbine typically includes a set of two or three large rotor blades mounted to a hub. The rotor blades and the hub together are referred to as the rotor. The rotor blades aerodynamically interact with the wind and create lift and drag, which is then translated into a driving torque by the rotor hub. The rotor hub is attached to and drives a main shaft, which in turn is operatively connected via a drive train to a generator or a set of generators that produce electric power. The main shaft, the drive train and the generator(s) are all situated within a nacelle, which is situated on top of a tower.

Such utility wind turbines have developed rapidly over the past few years. In addition to the expansion of locations, wind turbine designers have constantly strived to increase the power rating of the wind turbines. The power rating of any given wind turbine can, generally speaking, be increased by increasing the rotating speed of the wind turbine. However, as the rotational speed increases, the tip speed of the wind turbine increases as well. This increased tip speed drives an increase in the aero-acoustic or noise signature (e.g., the amount of noise emitted by noise emitting components) of the wind turbine. Local ordinances often set maximum noise signature limits, which limit the tip speed of wind turbines. To combat these sound limits, wind turbine designers have increased wind turbine diameters and lowered wind turbine rotational speeds in an effort to maintain a nearly constant tip speed, while increasing the power output capability of the wind turbine system.

This design compromise (larger diameters and slower rotational speeds) has had far reaching impacts on the cost of wind turbines and the cost of energy (COE) associated therewith. For example, larger diameters of the wind turbine increase the size and cost of the rotor blades. Furthermore, slower wind turbine speeds increase the size and complexity of electric generators and gearboxes used within the wind turbine, while larger low speed wind turbines react to larger aerodynamic forces, requiring larger bearings and larger support towers. By virtue of increasing the cost, size and complexity of various wind turbine components, the COE associated with a wind turbine can go up as well, which is substantially driven by the manufacturing costs, assembly costs and maintenance costs of the wind turbine. In addition, employing larger and more complex noise emitting wind turbine components, such as, generators, gearboxes, bearings, etc., can further increase the noise signature of the wind turbine, thereby alleviating at least some of the advantages associated with larger diameter and slower rotating wind turbines, while risking running into local noise ordinances. Thus, any increase in power rating of wind turbines by increasing the diameter of the wind turbine is still limited by the noise signature of the wind turbine.

Accordingly, it would be beneficial if a mechanism for suppressing noise emitted by various noise emitting components on a wind turbine were developed. It would be additionally beneficial if such a mechanism could facilitate increasing the rotational speed of the wind turbine for increased power production, while complying with local noise ordinances.

### SUMMARY OF THE DISCLOSURE

In accordance with one aspect of the present disclosure, an active noise suppression system for a wind turbine is disclosed. The active noise suppression system may include at least one noise measuring device capable of measuring an original noise signature of a noise emitting wind turbine component, a controller for determining an inverted noise signature for the original noise signature, an amplifier for amplifying the inverted noise signature and at least one speaker for emitting the amplified inverted noise signature.

In accordance with another aspect of the present disclosure, a method for suppressing noise from a noise emitting component on a wind turbine is disclosed. The method may include providing an active noise suppression system having at least one noise measuring device, a controller, an amplifier and one or more speakers. The method may further include measuring an original noise signature by the at least one noise measuring device of a noise emitting wind turbine component, calculating an inverted noise signature of the original noise signature by the controller and emitting the inverted noise signature.

In accordance with yet another aspect of the present disclosure, a wind turbine having an active noise suppression system is disclosed. The wind turbine may include a rotor having a plurality of blades and at least one noise emitting wind turbine component. The wind turbine may also include an active noise suppression system to suppress an original noise signature from the at least one noise emitting wind turbine component and the active noise suppression system may include at least one noise measuring device to measure the original noise signature, a controller to determine an inverted noise signature and one or more speakers to emit the inverted noise signature.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIG. 2 is an exemplary block diagram of an noise suppression system for use within the wind turbine of FIG. 1; and

FIG. 3 is a flowchart outlining steps that may be performed in reducing a noise signature of the wind turbine of FIG. 1 by utilizing the noise suppression system of FIG. 2.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

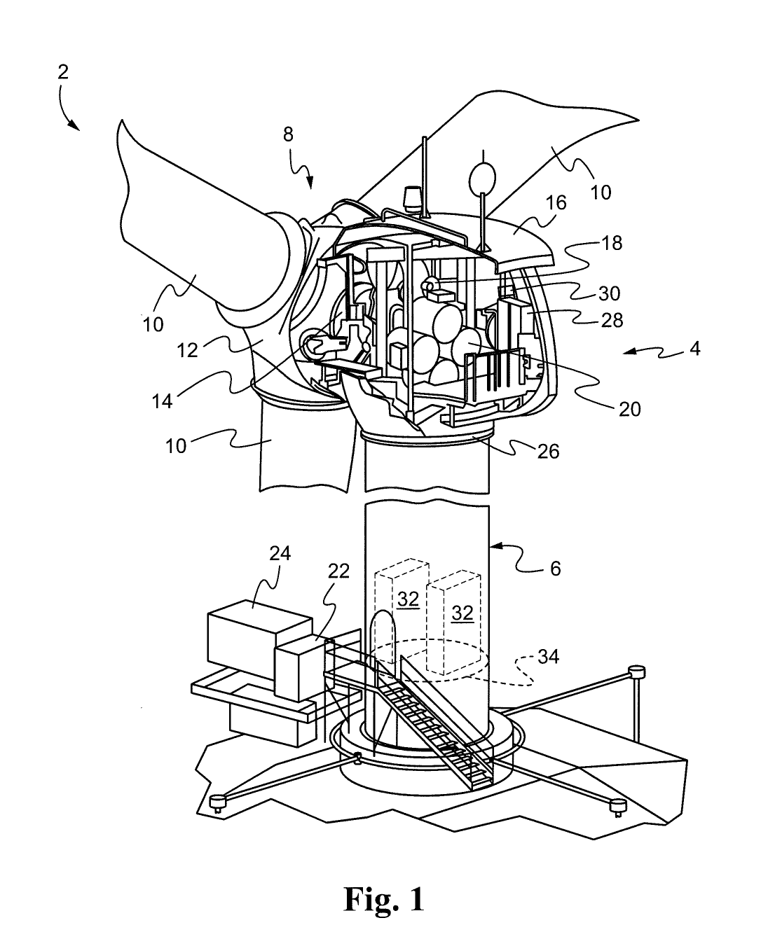

Referring now to FIG. 1, an exemplary wind turbine 2 is shown, in accordance with at least some embodiments of the present disclosure. While all the components of the wind turbine have not been shown and/or described, a typical wind turbine may include an up tower section 4 and a down tower section 6. The up tower section 4 may include a rotor 8 having a plurality of blades 10 connected to a hub 12. The blades 10 may rotate with wind energy and the rotor 8 may transfer that energy to a main shaft 14 situated within a nacelle 16. The nacelle 16 may include a drive train or gearbox 18, which may connect the main shaft 14 on one end to one or more generators 20 on the other end. The generators 20 may generate power, which may be transmitted from the up tower section 4 through the down tower section 6 to a power distribution panel (PDP) 22 and a pad mount transformer (PMT) 24 for transmission to a grid (not shown). The PDP 22 and the PMT 24 may also provide electrical power from the grid to the wind turbine for powering several components thereof.

In addition to the components of the wind turbine 2 described above, the up tower section 4 of the wind turbine may include several auxiliary components, such as, a yaw system 26 on which the nacelle 16 may be positioned to pivot and orient the wind turbine in a direction of the prevailing wind current or another preferred wind direction, a pitch control unit (PCU) (not visible) situated within the hub 12 for controlling the pitch (e.g., angle of the blades with respect to the wind direction) of the blades 10, a hydraulic power system (not visible) to provide hydraulic power to various components such as brakes of the wind turbine, a cooling system (also not visible), and the like. Notwithstanding the auxiliary components of the wind turbine 2 described above, it will be understood that the wind turbine 2 may include several other auxiliary components that are contemplated and considered within the scope of the present disclosure. Furthermore, a turbine control unit (TCU) 28 and a control system 30 (one or both of which may be classified as auxiliary components) may be situated within the nacelle 16 for controlling the various components of the wind turbine 2.

With respect to the down tower section 6 of the wind turbine 2, among other components, the down tower section may include a pair of generator control units (GCUs) 32 and a down tower junction box (DJB) 34 for routing and distributing power between the wind turbine and the grid. Several other components, such as, ladders, access doors, etc., that may be present within the down tower section 6 of the wind turbine 2 are contemplated and considered within the scope of the present disclosure.

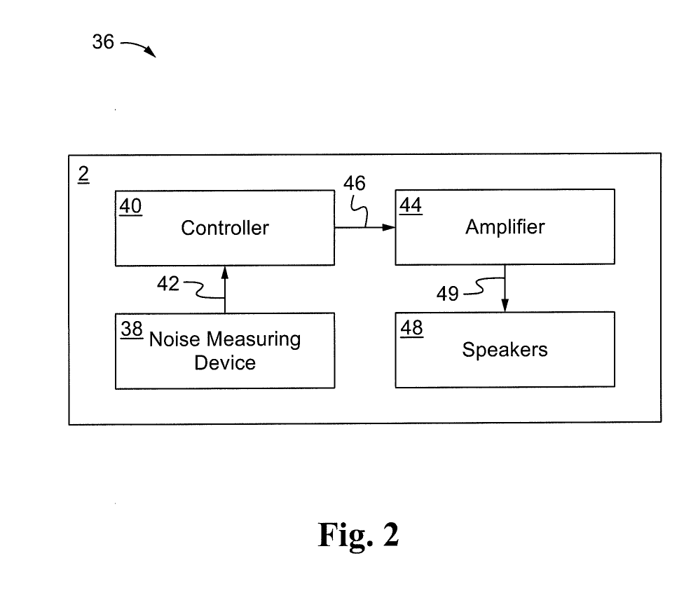

Referring now to FIG. 2, an exemplary block diagram of an active noise suppression system 36 is shown, in accordance with at least some embodiments of the present disclosure. As will be described further below, the active noise suppression system 36 may offer a way to combat the aero-acoustic or noise signature problem attributed to various noise emitting components of the wind turbine 2. Specifically, as will be described below, the active noise suppression system 36 may be employed to determine a localized noise signature of a particular one (or possibly group) of noise emitting wind turbine components and generate a synthetic sound wave to cancel out the localized noise signature. For example, the active noise suppression system 36 may be employed for suppressing the noise of various noise emitting wind turbine components, such as, various bearings, inverters, components of the gearbox 18, the blades 10, the generators 20, the control/cooling fans, etc.

As used herein, acoustic or noise signature (or simply noise) may be defined as any unwanted audible constant or intermittent acoustic perturbation, vibration or sound wave emitted by any component of the wind turbine 2. Accordingly, the active noise suppression system 36 may be termed as a noise control, noise cancellation, active noise reduction or anti-noise system. Furthermore, the active noise suppression system 36 may be capable of suppressing noise in real-time (e.g., the noise suppression may occur at the same rate or even faster than the rate at which the noise signature of the components may change). Moreover, the term suppression as used herein may mean at least a substantial reduction or possibly a complete attenuation in the intensity of the noise signature from any noise emitting wind turbine component.

In at least some embodiments, the active noise suppression system 36 may include a noise measuring device 38 that may be positioned on or in the vicinity of a noise emitting wind turbine component for measuring an original noise signature thereof. For example, the noise measuring device 38 may be positioned on or within the hub 12, the nacelle 16, anywhere on the up tower or the down tower sections 4 and 6, respectively, around the perimeter of the wind turbine 2, or any other location that may be capable of monitoring the original noise signature radiating from the noise emitting wind turbine component. Furthermore, in at least some embodiments, the noise measuring device 38 may be one or more microphones capable of capturing the original noise signature emitted by the noise emitting wind turbine component and converting the noise signature into an electrical signal for transmission, as described below. In other embodiments, other types of noise measuring devices, such as, noise or sound meters, sound vibrations meters, etc. may be employed. Additionally, a single one of the noise measuring device 38 or a plurality thereof may be employed for measuring the original noise signature of one or more noise emitting wind turbine component(s). The original noise signature captured by the noise measuring device 38 may then be transferred to a controller 40 via communication link 42.

The controller 40 may be a stand-alone embedded or general purpose processing system having any of a variety of volatile or non-volatile memory/storage devices, such as, flash memory, read only memory (ROM), programmable read only memory (PROM), erasable programmable read only memory (EPROM), electronically erasable programmable read only memory (EEPROM), etc., processing devices and computer readable media, such as, joy sticks, flash drives, optical disc drives, floppy discs, magnetic tapes, drums, cards, etc. Other types of computing, processing as well as reporting and storage devices may be present within (or used in conjunction with) the controller 40. Furthermore, the controller 40 may be located within the wind turbine 2 (e.g., within the nacelle 16 or the down tower section 6), or alternatively, it may be located remotely at a remote monitoring and diagnostics center (RMDC) capable of communicating with the noise measuring device 38 through the communication link 42. In at least some embodiments, the controller 40 may possibly be a part of the TCU 28 and/or the control system 30 as well. Relatedly, the communication link 42 is intended to be representative of a variety of analog or digital communication/data transfer media that are commonly employed in wind turbine settings including, but not limited to, wired or wireless links, buses, radio channels, or links involving the internet or the World Wide Web. Other types of communication links may also be employed.

Upon receiving the original noise signature from the noise measuring device 38, the controller 40 may then determine (e.g., calculate) an inverted noise signature. Inverting an acoustic wave is known and, therefore, it has not been described in detail. Generally speaking, the acoustic sound wave of the original noise signature may be inverted by the controller 40 by generating a reflective acoustic sound wave with the same amplitude as the original acoustic sound wave but with an inverted phase (e.g., out of phase or anti-phase) thereof. The inverted noise signature may then be transmitted to a power amplifier 44 through a communication link 46 for amplifying the inverted noise signature to a power level of the original noise signature.

The power amplifier 44 may then drive one or more speakers 48 through a communication link 49, which may emit the inverted noise signature to cancel out the original noise signature. Generally speaking, the acoustic sound wave in the original noise signature may combine with the inverted sound wave in the inverted noise signature to create a new synthetic wave, by a process of interference to cancel each other out, thereby effectively suppressing the noise from the noise emitting wind turbine component. The speakers 48 may be co-located with the noise measuring device 38 or they may be mounted on or near the noise emitting wind turbine component or any other location where noise suppression from the noise emitting wind turbine component is desired. For example, the speakers 48 may be mounted on the blades 10, the nacelle 16, the up tower or the down tower sections 4 and 6, respectively, and/or the ground around the wind turbine perimeter. Similar to the noise measuring device 38, a single one of the speakers 48 or a plurality thereof may be employed for emitting the inverted noise signature for cancelling the noise from one or more of the noise emitting wind turbine component(s). Additionally, in other embodiments, devices other than the speakers 48 for emitting the inverted noise signature may be employed as well.

It will also be understood that while the active noise suppression system 36 has been described with the controller 40 and the power amplifier 44 being separate components, in at least some embodiments, both of those components may be part of a single system. Additionally, the communication links 46 and 49 may be similar to the communication link 42. Furthermore, a single one of the active noise suppression system 36 may be employed for suppressing noise of a single one of the noise emitting wind turbine component or, alternatively, a single one of the active noise suppression system may be employed for suppressing noise of multiple noise emitting wind turbine components.

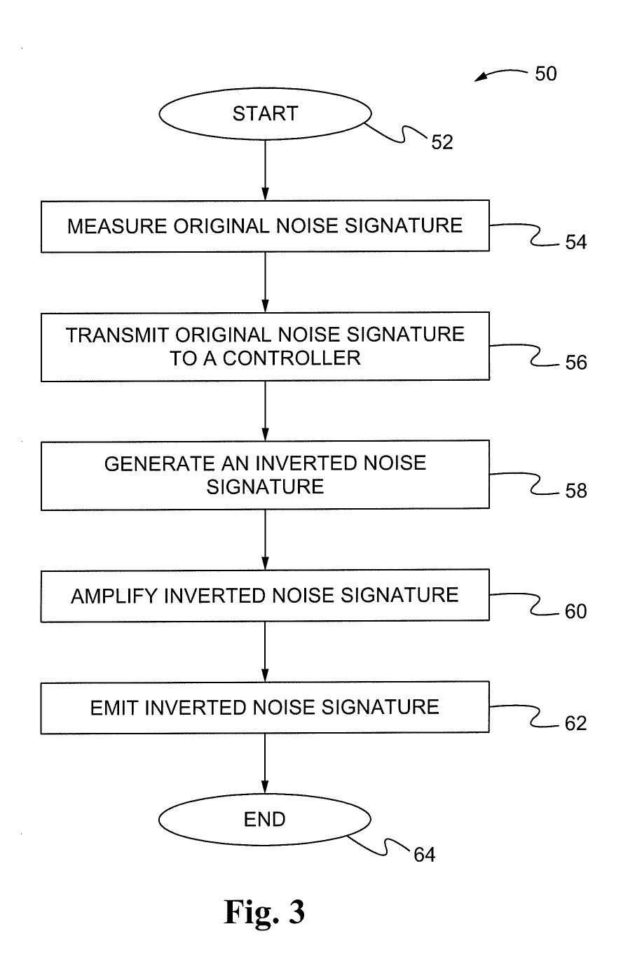

Turning now to FIG. 3, a flowchart 50 outlining exemplary steps that may be performed in suppressing noise from a noise emitting wind turbine component is shown, in accordance with at least some embodiments of the present disclosure. As shown, after starting at a step 52, an original noise signature of a noise emitting wind turbine component may be measured by the noise measuring device 38 at a step 54. The measured original noise signature may then be transmitted to the controller 40 at a step 56, which may then generate an inverted noise signature at a step 58. As described above, the inverted noise signature may have a similar or same amplitude as the original noise signature but with a different phase. The inverted noise signature may be amplified by the power amplifier 44 at a step 60 and it may be emitted via the speakers 48 at a step 62. The steps 52-62 may then be continuously repeated for actively controlling and/or suppressing the noise signature emitted from the particular noise emitting wind turbine component. The process may end at a step 64.

Thus, the present disclosure sets forth a system and method for actively suppressing noise from various noise emitting wind turbine components. The system and method may include a noise measuring device to measure an original noise signature of at least one of the noise emitting wind turbine components, a controller to generate an inverted noise signature and a power amplifier to amplify the inverted noise signature to match the power level of the original noise signature. The inverted noise signature may then be emitted via one or more speakers to effectively cancel the original noise signature, thereby reducing and/or suppressing the noise emitted from the noise emitting wind turbine component.

Advantageously, the use of the above described active noise canceling system and method may allow increasing a rotational speed of the wind turbine 2. Increasing the rotational speed of the wind turbine 2 may decrease the diameter of the wind turbine for a given output power, thereby reducing the size and complexity of the wind turbine blades, the gearbox, and the electric power generation system (e.g., the generators). Increasing the rotational speed may, thus, reduce the overall cost of the wind turbine, thereby resulting in a decreased cost of energy (COE). The cost and complexity of other wind turbine equipment that are currently designed to be quiet may be decreased as well.

It will be understood that while the above disclosure has been described with regular wind turbines having gearboxes, the disclosure is equally applicable to direct drive wind turbines that do not have a gearbox. In addition to wind turbines having direct drive or gearbox based drive trains, the active noise suppression system described above may also be applicable to chain drive, belt drive, friction drive, hydraulic (e.g., hydrostatic) and other types of drive train based wind turbines. Furthermore, the above disclosure may also allow existing wind turbines to be retrofitted with the noise suppression system described above, thereby offering a capability to increase the power production of currently installed wind turbines.

Additionally, the active noise suppression system may be employed in conjunction with passive noise suppression systems, such as, various noise enclosures, foam padding, or any other device, equipment or material that may passively limit noise from escaping the noise generating component.

While only certain embodiments have been set forth, alternatives and modifications will be apparent from the above description to those skilled in the art. These and other alternatives are considered equivalents and within the spirit and scope of this disclosure and the appended claims.

We claim:

1. An active noise suppression system for a wind turbine, comprising:
at least one noise measuring device capable of measuring an original noise signature of a noise emitting wind turbine component;
a controller for determining an inverted noise signature for the original noise signature;
an amplifier for amplifying the inverted noise signature; and
at least one speaker for emitting the amplified inverted noise signature.

2. The active noise suppression system of claim 1, wherein the at least one noise measuring device is one or more microphones.

3. The active noise suppression system of claim 1, wherein the at least one noise measuring device is positioned in a vicinity of the noise emitting wind turbine component.

4. The active noise suppression system of claim 1, wherein the noise emitting wind turbine component is at least one of a gearbox, a generator, an inverter, bearings and blades of the wind turbine.

5. The active noise suppression system of claim 1, wherein the wind turbine is a direct drive wind turbine.

6. The active noise suppression system of claim 1, wherein the inverted noise signature has the same amplitude and a different phase from that of the original noise signature.

7. The active noise suppression system of claim 1, wherein the amplifier amplifies the inverted noise signature to a same power level as that of the original noise signature.

8. The active noise suppression system of claim 1, wherein the one or more speakers are co-located with the at least one noise measuring device.

9. The active noise suppression system of claim 1, wherein the active noise suppression system is used in conjunction with a passive noise suppression system.

10. A method for suppressing noise from a noise emitting component on a wind turbine, the method comprising:
providing an active noise suppression system having at least one noise measuring device, a controller, an amplifier and one or more speakers;
measuring an original noise signature by the at least one noise measuring device of a noise emitting wind turbine component;
calculating an inverted noise signature of the original noise signature by the controller; and
emitting the inverted noise signature.

11. The method of claim 10, wherein measuring the original noise signature further comprises transmitting the original noise signature to the controller.

12. The method of claim 10, wherein calculating the inverted noise signature comprises generating a reflective sound wave of the original noise signature.

13. The method of claim 12, further comprising amplifying the reflective sound wave with the amplifier to a power level of the original noise signature.

14. The method of claim 10, further comprising cancelling the original noise signature with the inverted noise signature by generating a synthetic sound wave.

15. The method of claim 10, further comprising repeating the measuring, calculating and emitting steps to actively suppress noise from the noise emitting wind turbine component.

16. A wind turbine having an active noise suppression system, the wind turbine comprising;
a rotor having a plurality of blades;
at least one noise emitting wind turbine component;
an active noise suppression system to suppress an original noise signature from the at least one noise emitting wind turbine component, the active noise suppression system having (a) at least one noise measuring device to measure the original noise signature; (b) a controller to determine an inverted noise signature; and (c) one or more speakers to emit the inverted noise signature.

17. The wind turbine of claim 16, wherein the at least one noise emitting wind turbine component comprises at least one of a gearbox, the plurality of blades, a generator, an inverter and bearings of the wind turbine.

18. The wind turbine of claim 16, wherein the wind turbine is a direct drive wind turbine.

19. The wind turbine of claim 16, wherein the active noise suppressing system further comprises an amplifier to amplify the inverted noise signature.

20. The wind turbine of claim 16, wherein the at least one noise measuring device is positioned around a perimeter of the wind turbine.
